(19) United States
(12) Patent Application Publication
(10) Pub. No.: US 2012/0036011 A1
(43) Pub. Date: Feb. 9, 2012

(54) Search Personalization Using Identifiers and Authentication State

(75) Inventors: Michael A. Schechter, Sammamish, WA (US); Michael Gradek, New York, NY (US); Sridharan K. Iyer, Woodinville, WA (US); Gayathri Ravichandran Geetha, Bellevue, WA (US); Igor Shoshitaishvili, Bellevue, WA (US); Jonathan M. Garcia, Duvall, WA (US); Aravind Bala, Redmond, WA (US)

(73) Assignee: MICROSOFT CORPORATION, Redmond, WA (US)

(21) Appl. No.: 12/851,065

(22) Filed: Aug. 5, 2010

(51) Int. Cl. G06Q 30/00; G06F 21/00; G06F 17/30; G06F 3/01

(52) U.S. Cl. 705/14.49; 715/747; 726/3; 707/728; 707/E17.014

(57) ABSTRACT

Systems, methods, and computer media for personalizing a web page and for personalizing user search query results are provided. A request to view a web page, such as a user search query that produces a search result web page, is received from a computing device. A computing device identifier is detected. Device-specific data corresponding to the detected computing device identifier is accessed. Upon detecting at least one user identifier having an authentication state, user-specific data corresponding to the detected user identifier and authentication state is accessed. The web page is personalized based on at least one of the accessed device-specific data and the accessed user-specific data.

### BACKGROUND

Internet use and the number of web pages accessible via the Internet are continually increasing. In an effort to attract customers, advertisers, and advertising revenue, web page providers attempt to provide the most interesting and relevant content possible. One method of providing relevant content is to personalize a web page. Typically, a web page is personalized according to a computing device identifier captured in a browser cookie. Thus, web page providers track a particular computer's browsing actions and attempt to provide content, options, and/or advertisements consistent with the actions. Multiple users may use a single computing device, however, which can cause a web page to be personalized incorrectly when a new user begins to browse after the web page has been personalized according to another user's actions.

Some web page providers personalize content by allowing individual users to establish accounts with usernames and passwords. The user may provide demographic information or select preferences that enable the web page to be personalized in a way that will appeal to the user. Users may log in to their accounts from a variety of computing devices in a variety of environments, however, which may result in an incorrectly personalized web page depending on the user's context. For example, even though a web page may be personalized according to a user account, the user may be accessing the web page from a work computer and thus have specific needs and interests that differ from the user's needs and interests when logged in from a home computer. The personalization of the web page, however, does not distinguish between the two contexts.

Web page personalization is especially important in an Internet search engine context. Internet searching has become increasingly common in recent years, and users have become accustomed to performing keyword and other search queries for a wide range of information. As the number of web pages and domains continues to grow, a search query often returns many more results than a user is actually interested in viewing. In an attempt to combat this information overload, conventional search engines often present search results ranked in order of relevance to the user's search query. Although relevance ranking may help identify generally useful results, the identified results may not be useful to a particular user. Personalized search results can further help direct users to relevant and desired results, but personalization by either computing device identifier or user login suffers from the above-mentioned deficiencies.

### SUMMARY

Embodiments of the present invention relate systems, methods, and computer media for personalizing a web page and for personalizing user search query results. Using the methods described herein, a user request to view a web page can be received from a computing device. A computing device identifier associated with the computing device can be detected. Device-specific data corresponding to the detected computing device identifier can be accessed. Upon detecting at least one user identifier having an authentication state, user-specific data corresponding to the detected user identifier and authentication state can be accessed. The web page can be personalized based on at least one of the accessed device-specific data and the accessed user-specific data. The user request can be a user search query, and the personalized web page can be a search results page.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary web page personalization system for implementing embodiments of the present invention;

FIG. 3 is a flow chart of an exemplary method for personalizing a web page;

FIG. 4 is a block diagram of an exemplary search result page personalization system for implementing embodiments of the present invention; and

FIG. 5 is a flow chart of an exemplary method for personalizing a search result page.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention provide systems, methods, and computer media for personalizing web pages and personalizing search results. In accordance with embodiments of the present invention, a web page is personalized before presentation to a user. As discussed above, web page providers often seek to personalize web page content to attract users and advertisers. Web page providers typically rely on either a computing device identifier or a user login to gather and/or access information that can be used to personalize the web page. As also discussed above, both computing device identifiers and user identifier have deficiencies. Computing device identifiers indicate only the machine from which a request originates. Because multiple users may send requests from a single machine, a web page may be personalized for a previous user and be unhelpful to a current user. Similarly, while a user login allows a web page to be personalized for a particular user, the personalization may not be appropriate given the user's context (e.g., at work, at home, on wireless device). Additionally, the existence of two schemes for personalizing web pages based on two different identifier types creates security and privacy concerns due to potential comingling of data.

In accordance with embodiments of the present invention, a user request to view a web page is received from a user at a computing device. The web page is personalized before the page is presented to the user by considering device-specific data corresponding to a detected computing device identifier and user-specific data corresponding to a detected user identifier. The user-specific data and device-specific data are segregated according to identifier. For a given user request, only the data associated with detected identifiers is available. Both the user-specific data and device-specific data may include, among other data, settings, search history, browsing history, preferences, application settings, application data, user categorization based on search or browsing history, and demographic data. The detected user identifier may have a number of possible authentication states, including “identified but unauthenticated” and “identified and authenticated.” The amount of user-specific data available for use in personalization varies according to the authentication state.

User-specific data provides information relating to a particular user, but, as stated above, the user's context is typically not known. Computing device identifiers can be used to provide user context. For example, a user may have a different computer at home than she has at work. By identifying the machine from which the request originates, appropriate “home” or “work” personalization can occur. One particularly useful context in which web page personalization can occurs is for user search queries. User search history, categorization, and preferences can be considered to present personalized search results based on the user's identity and context.

In one embodiment of the present invention, a user request to view a web page is received from a computing device. A computing device identifier is detected. Device-specific data corresponding to the detected computing device identifier is then accessed. Upon detecting at least one user identifier having an authentication state, user-specific data corresponding to the detected user identifier and authentication state is accessed. The web page is then personalized based on at least one of the accessed device-specific data and the accessed user-specific data.

In another embodiment, a user search query is received from a computing device. A computing device identifier is detected. Device-specific data corresponding to the detected computing device identifier is accessed. Upon detecting at least one user identifier having an authentication state, user-specific data corresponding to the detected user identifier and authentication state is accessed. One or more web pages relevant to the user search query are identified. The relevant web pages are ranked based on at least one of the accessed device-specific data and the accessed user-specific data. A personalized search result page including the ranked relevant web pages is generated.

In still another embodiment, a user search query is received from a computing device. A computing device identifier is detected. At least one user identifier having an authentication state is detected. The authentication state is one of (1) identified but not authenticated or (2) identified and authenticated. Device-specific data corresponding to the detected computing device identifier is accessed. User-specific data corresponding to the detected user identifier and authentication state is accessed. One or more web pages relevant to the user search query are identified. The relevant web pages are ranked based on at least one of the accessed device-specific data and the accessed user-specific data. A personalized search result page including the ranked relevant web pages is generated.

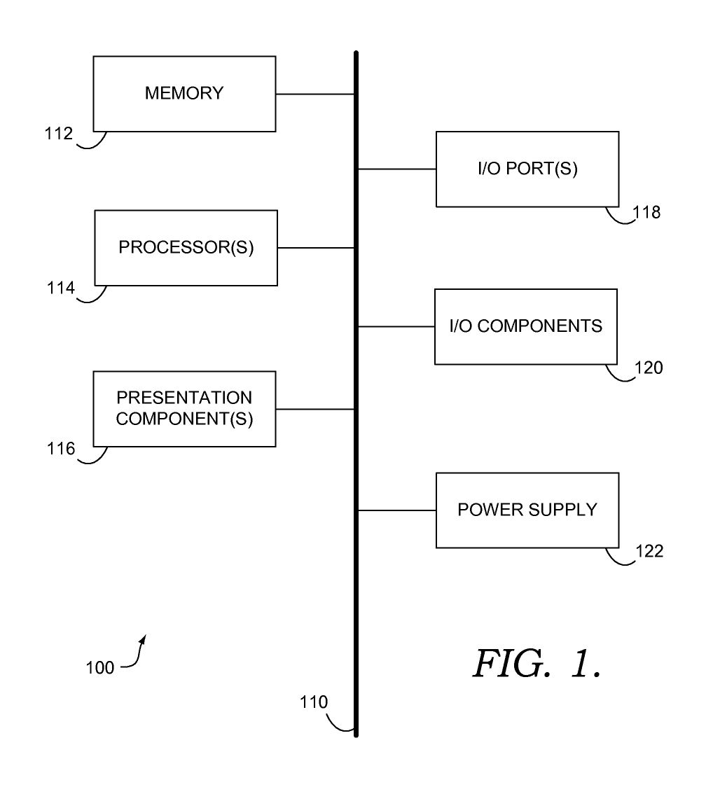

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

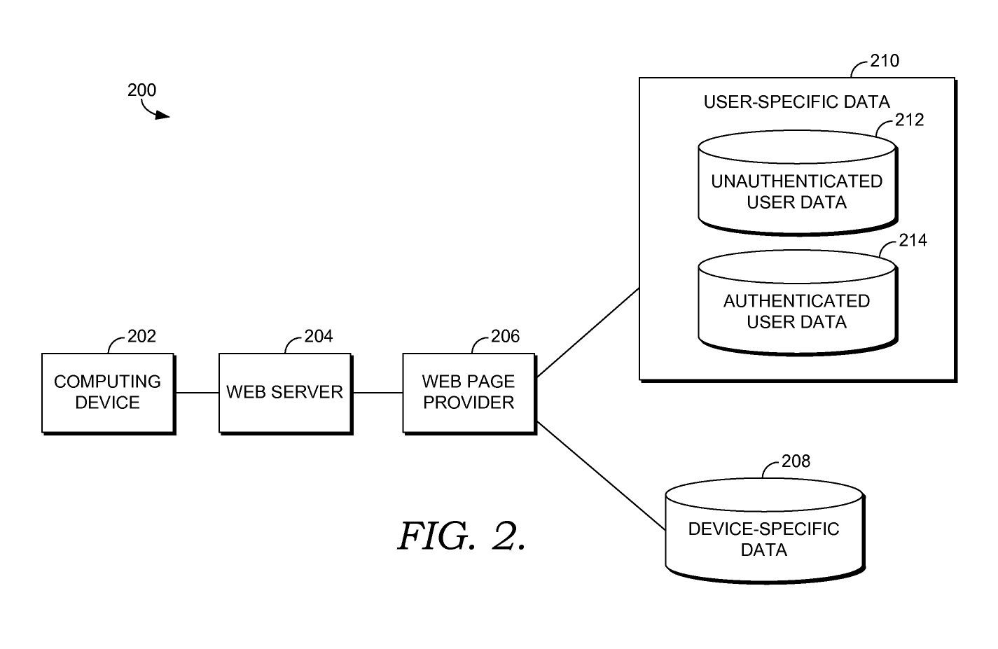

As discussed previously, embodiments of the present invention provide methods and computer media for personalizing web pages and personalizing search results. Embodiments of the present invention will be discussed with reference to FIGS. 2-5.

FIG. 2 illustrates a block diagram of a system 200 for personalizing web pages. Computing device 202 receives a request from a user to view a web page. The request is communicated through web server 204 to web page provider 206. Web page provider 206 accesses device-specific data store 208 and user-specific data store 210 to personalize the web page for the user. Device-specific data and user-specific data may include, among other things, settings, search history, browsing history, preferences, application settings, application data, user categorization based on search or browsing history, and demographic data.

Device-specific data and user-specific data are gathered from a variety of sources including browser, search provider, and web domain records. Many browsers, search providers, and web domains record user actions and history for a variety of purposes. For example, when a search provider receives user search queries, the search provider tracks the queries and subsequent actions associated with the queries, such as clicking on a presented search result link. If a user is not logged in, the search provider stores the actions in association with the computing device identifier and may store the actions for a shorter length of time than if the user were logged in.

In some instances, a number of web domains or services may share user history among themselves. For example, one entity may provide a news website, search engine, e-mail, and other services accessible through a single username and password. The history, preferences, etc, of the user for each service is available to every other service provided by the entity. In other instances, a user may have accounts with various entities, and the entities have agreed to allow a single login from one account with a first entity to access information in other accounts of the same user with different entities. In this way, a user could perform a single login to access email from provider A and access the user's search history and preferences from provider B or social media events from provider C. Single logins for multiple websites/domains, recording user activity, and other methods of gathering user data are well known in the art.

The particular data used to personalize a web page may vary. For example, if a user has requested to view a mapping web page that provides directions, any accessible user or device-specific data may be used to personalize the presented mapping web page. The mapping provider may consider user-specific data that relates to an email account or search engine history in place of or in addition to mapping history. For example, the mapping provider could present a default map of the user's home address based on profile information stored for the user's email address. Alternatively, the mapping provider could present as the default map a frequently mapped location as determined from the mapping provider's history or include frequently searched destinations as selectable options. The specific items of user-specific data considered in personalization depend upon the web page provider's goals and other considerations.

As discussed above, various authentication states exist for a user. In one embodiment, three authentication states are possible: (1) user not identified, (2) user identified but unauthenticated, and (3) user identified and authenticated. Other authentication states are possible. In authentication state (1), a user is not identified. The system has no way to access user-specific data in this authentication state. Only device-specific data can be used to personalize a web page for a request in which there is no user identifier.

In authentication state (2), a user has been identified, but the user is not currently authenticated. This may occur when, for example, a user has previously been logged in to a web domain or web page provider but has logged out. Depending upon the login type, the username may remain for convenience of the user. The user identifier (username) is detected, but the identifier has not been authenticated. In some types of login systems, after a user logs out, both the username and password are removed and the user then has authentication state (1). Authentication state (2) also may occur, for example, when a user is logged in, closes the browser without logging out, and later reopens the browser. Similarly, authentication state (2) may occur when a browser cookie for a logged-in user expires. Authentication state (3) occurs when a user identifier is detected that has been authenticated, such as when a user is currently logged in to a web domain or web page provider. Authentication states (1), (2), and (3), can be thought of as: (1)—“we don't know who you are;” (2)—“we think we know who you are, but we can't be sure;” and (3) “we know who you are to the best of our ability.”

User-specific data accessible in authentication states (2) and (3) is illustrated in FIG. 2 by unauthenticated user data store 212 and authenticated user data store 214. Unauthenticated user data store 212 is data associated with a user identifier but not authenticated. Authenticated user data store 214 is data associated with a user identifier that is authenticated. As discussed above, the level of data accessible for personalization depends upon the authentication state. In many cases, personalization includes making data such as search or purchase history available to the user. It is thus extremely important to only allow access to data that corresponds to a user's authentication state.

For example, if a request to view a web page is received and no user identifier is detected, the user is in authentication state (1). Sensitive information such as credit card payment information, home address, telephone number, or possibly even search history should not be accessible or used to personalize in such a case. Device-specific data is typically less sensitive than unauthenticated user data, which is in turn typically less sensitive than authenticated user data. The dividing lines between which data should be stored as unauthenticated user data and which should be stored as authenticated user data depends upon a web domain or web page provider's needs and preferences. Wherever the lines are drawn, security and privacy concerns typically guide the categorization. In addition to access to sensitive data, authentication state may also affect read and write permissions and information retention.

Personalizing web pages using only user-specific data can still result in web pages that are inappropriate for a user given the user's context. Considering the mapping service example presented above, a user logged in to a mapping service may be presented with a default map of the user's home address. Personalization occurred after authenticated user data was accessed to determine the user's home address and a decision was made to produce a default map with that home address. The user, however, may have logged in to her account from her work computer. In such a situation, it is likely that the user desired driving directions from her work location to a destination. The mapping service's attempt at personalization, producing a default map with the user's home address, is not helpful in this situation. By detecting a computing device identifier, however, the mapping service is able to gain context for the user's current session. The mapping service can recognize that the computing device identifier is the user's work computer, and only personalize based on user-specific data that corresponds to the work computer.

In one embodiment, the personalized web page can include reduced or expanded content depending on the computing device identifier. For example, if it determined from the computing device identifier that a user is requesting to view a web page from a work computer, when the user would likely have limited time to view content, the personalized display can include a limited number of targeted content items. In contrast, if it is determined that the user has requested to view a web page from her home computer, where she is more likely to have time to view content, additional content may be included in the personalized web page. Advertisements presented in association with a web page can be similarly personalized.

In the web page personalization system shown in FIG. 2, web server 204 and web page provider 206 may be the same component or functional areas of one component. In some embodiments, web server 204 detects device and user-specific identifiers, along with corresponding authentication states, from sources such as cookies. The identifier and authentication state information is communicated to the middle tier of an application associated with web page provider 206, which selects particular identifiers for which to retrieve associated data from the data stores, including device-specific data store 208, unauthenticated user data store 212, and authenticated user data store 214. The data stores have access control lists or other security means and are partitioned according to user identifier and authentication state. Thus, when presented with particular user or device-specific identifiers and authentication states, the data stores only provide access to the appropriate information, eliminating security and privacy concerns.

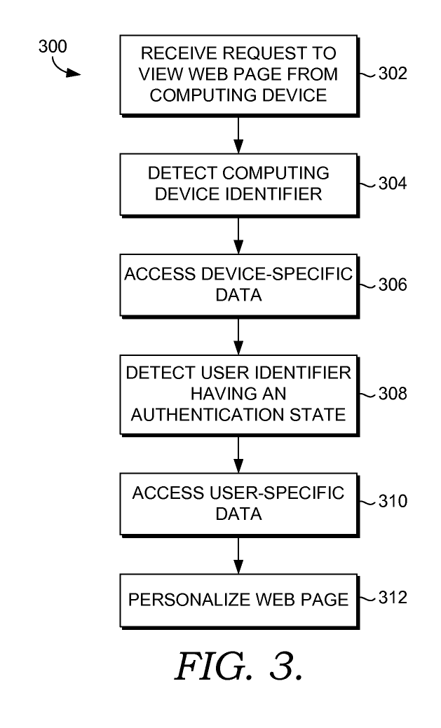

FIG. 3 illustrates a method 300 of personalizing a web page. In step 302, a request to view a web page is received from a computing device. In step 304, a computing device identifier associated with the computing device is detected. The identifier may be stored in a cookie. In step 306, device-specific data corresponding to the computing device is accessed. A user identifier having an authentication state is detected in step 308. User-specific data corresponding to the user identifier is accessed in step 310. In some embodiments, multiple user identifiers are detected and one or more particular identifiers for which corresponding data is to be accessed are selected. In step 312, the web page is personalized based on the accessed device-specific and user-specific data.

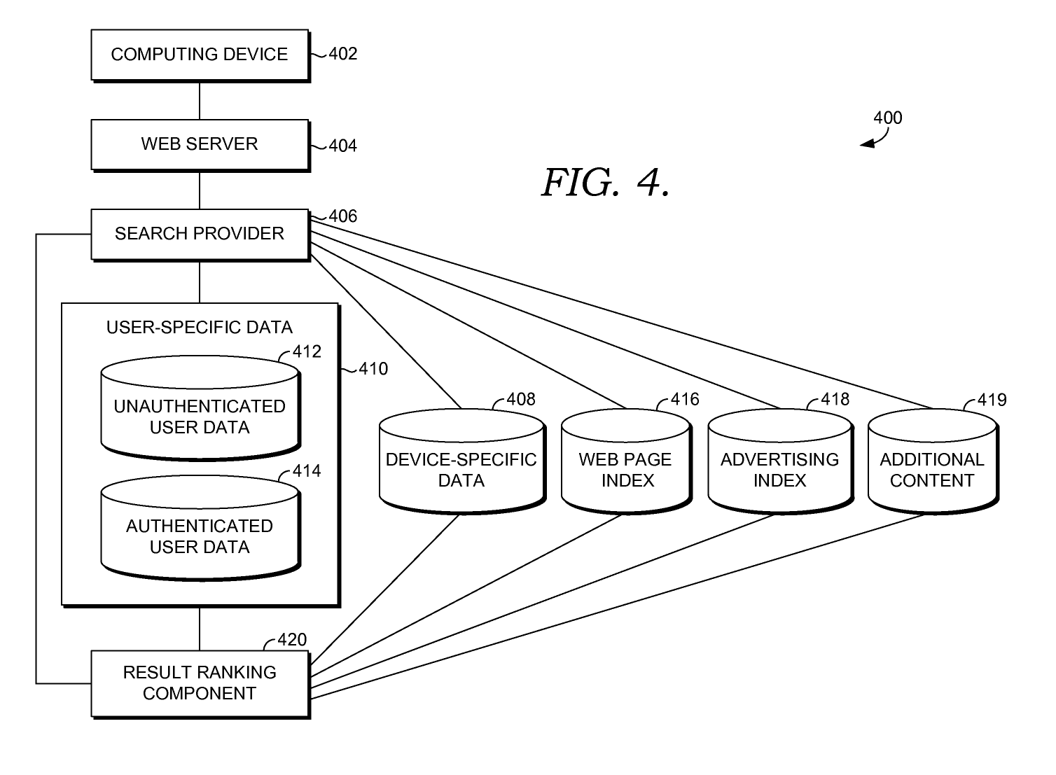

As discussed above, web page personalization is desirable for Internet search providers. FIG. 4 illustrates a system 400 for personalizing search results. A user enters a search query at computing device 402. The search query is communicated through web server 404 to search provider 406. In some embodiments, web server 404 and search provider 406 are one entity or component. Web server 404 detects a device-specific identifier and one or more user-specific identifiers and communicates the identifiers to search provider 406. Search provider 406 selects particular identifiers for which it would like to access associated data for search result personalization and communicates the identifiers to device-specific data store 408 and user-specific data store 410. Unauthenticated user data 412 and authenticated user data 414 are stored according to user identifier in user-specific data store 410. Only the device-specific data corresponding to computing device 402 and user-specific data corresponding to the selected user identifier and authentication state are accessible for personalization in response to the user search query.

In some embodiments, authenticated user data store 414 contains all of the data stored in unauthenticated user data store 412. In other embodiments, a decision is made to store some user-specific data as accessible when the user is unauthenticated and some as accessible when the user is authenticated, and when it is determined that a user is authenticated, both unauthenticated user data store 412 and authenticated user data store 414 are accessible.

Personalization of search results may include accessing user-specific data relating to user categorization. For example, the user may be categorized by the search provider as a sports enthusiast, shopper, casual user, or other category. Recent search history associated with the user or device may also be considered. As discussed above, the combination of a computing device identifier and user identifier provides a more complete level of personalization that can account for not just a user's identity but also a user's context. Search provider 406 may also consider the user's demographic information, geographic location, expressed preferences or settings, or other information.

Search provider 406 accesses web page index 416, advertising index 418, and additional content 419 to identify web pages, advertisements, and additional content relevant to the received user query. Additional content 419 may include answers to particular queries. For example, if a user searches for a particular sporting event score, scientific constant value, population statistic, or other information for which a fast and complete answer may be easily obtained, such an answer can be presented directly to the user without providing a link to a web page containing this information. Result ranking component 420 assembles personalized results based on the identified relevant web pages, advertisements, device-specific data, and user-specific data. The personalized results are provided to search provider 406. A personalized search results web page is generated and communicated to computing device 402 through web server 404.

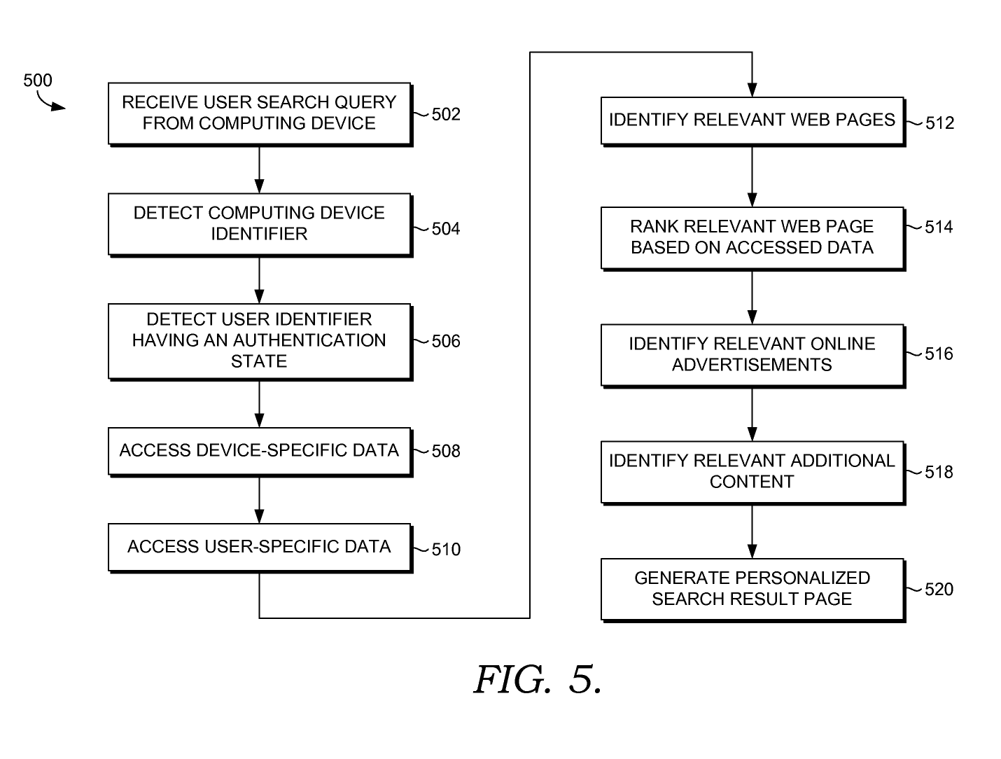

FIG. 5 illustrates a method 500 of personalizing a search results web page. In step 502, a user search query is received from a computing device. In step 504, a computing device identifier corresponding to the computing device is detected. In step 506, a user identifier having an authentication state is detected. In step 508, device-specific data corresponding to the computing device identifier is accessed. In step 510, user-specific data corresponding to the user identifier is accessed. Web pages relevant to the user search query are identified in step 512. The identified relevant web pages are ranked based on the accessed device-specific and user-specific data in step 514. Relevant online advertisements are identified in step 516. In step 518, relevant additional content is identified. A personalized search result page is then generated in step 520, the search result page including the ranked results, online advertisements, and additional content. In some embodiments, steps 516 and/or 518 are omitted.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer storage media storing computer-executable instructions for performing a method for personalizing a web page, the method comprising:
receiving a user request to view a web page from a computing device;
detecting a computing device identifier;
accessing device-specific data corresponding to the detected computing device identifier;
upon detecting at least one user identifier having an authentication state, accessing user-specific data corresponding to the detected user identifier and authentication state; and
personalizing the web page based on at least one of the accessed device-specific data and the accessed user-specific data.

2. The media of claim 1, wherein the user request is a user search query, and wherein the web page is a search results page.

3. The media of claim 1, wherein user-specific data comprises one or more of settings, history, preferences, stored data, user categorization, financial information, and demographic data.

4. The media of claim 1, wherein the authentication state is one of (1) identified but not authenticated or (2) identified and authenticated, and wherein more user-specific data is available for access when the authentication state is (2) identified and authenticated than when the authentication state is (1) identified but not authenticated.

5. The media of claim 1, wherein the detected computing device identifier indicates that the computing device is one of public computer, home computer, work computer, portable computer, or handheld device.

6. The media of claim 1, further comprising:
identifying one or more online advertisements that are at least one of: (1) relevant to the user request; (2) relevant to the accessed user-specific data; or (3) relevant to the accessed device-specific data; and
including the identified online advertisements in the personalized web page.

7. One or more computer storage media storing computer-executable instructions for performing a method for personalizing user search query results, the method comprising:
receiving a user search query from a computing device;
detecting a computing device identifier;
accessing device-specific data corresponding to the detected computing device identifier;
upon detecting at least one user identifier having an authentication state, accessing user-specific data corresponding to the detected user identifier and authentication state;
identifying one or more web pages that are relevant to the user search query;
ranking the relevant web pages based on at least one of the accessed device-specific data and the accessed user-specific data; and
generating a personalized search result page including the ranked relevant web pages.

8. The media of claim 7, wherein user-specific data comprises one or more of settings, search history, browsing history, preferences, application settings, application data, user categorization based on search or browsing history, and demographic data.

9. The media of claim 7, wherein user-specific data is stored according to authentication state.

10. The media of claim 7, wherein the authentication state is one of (1) identified but not authenticated or (2) identified and authenticated, and wherein more user-specific data is available for access when the authentication state is (2) identified and authenticated than when the authentication state is (1) identified but not authenticated.

11. The media of claim 7, wherein the detected computing device identifier indicates that the computing device is one of public computer, home computer, work computer, portable computer, or handheld device.

12. The media of claim 11, wherein the personalized search result page is designed for display on the indicated device type.

13. The media of claim 7, further comprising:
identifying one or more online advertisements that are at least one of: (1) relevant to the user search query; (2) relevant to the accessed user-specific data; or (3) relevant to the accessed device-specific data; and
including the identified online advertisements in the generated search results page.

14. One or more computer storage media storing computer-executable instructions for performing a method for personalizing user search query results, the method comprising:
receiving a user search query from a computing device;
detecting a computing device identifier;
detecting at least one user identifier having an authentication state,
wherein the authentication state is one of (1) identified but not authenticated or (2) identified and authenticated;
accessing device-specific data corresponding to the detected computing device identifier;
accessing user-specific data corresponding to the detected user identifier and authentication state;
identifying one or more web pages that are relevant to the user search query;
ranking the relevant web pages based on at least one of the accessed device-specific data and the accessed user-specific data; and
generating a personalized search result page including the ranked relevant web pages.

15. The media of claim 14, wherein user-specific data comprises one or more of settings, search history, browsing history, preferences, application settings, application data, user categorization based on search or browsing history, and demographic data.

16. The media of claim 14, wherein user-specific data is stored according to authentication state.

17. The media of claim 14, wherein more user-specific data is available for access when the authentication state is (2) identified and authenticated than when the authentication state is (1) identified but not authenticated.

18. The media of claim 14, wherein the detected computing device identifier indicates that the computing device is one of public computer, home computer, work computer, portable computer, or handheld device.

19. The media of claim 18, wherein the personalized search result page is designed for display on the indicated device type.

20. The media of claim 14, further comprising:
identifying one or more online advertisements that are at least one of: (1) relevant to the user search query; (2) relevant to the accessed user-specific data; or (3) relevant to the accessed device-specific data; and
including the identified online advertisements in the generated search results page.
